(19) United States
(12) Patent Application Publication
(10) Pub. No.: US 2015/0006932 A1
(43) Pub. Date: Jan. 1, 2015

(54) POWER SUPPLY APPARATUS

(71) Applicant: SAMSUNG ELECTRO-MECHANICS CO., LTD., Suwon (KR)

(72) Inventors: Jae Kuk KIM, Suwon (KR); Chong Eun KIM, Suwon (KR)

(73) Assignee: SAMSUNG ELECTRO-MECHANICS CO., LTD., Suwon (KR)

(21) Appl. No.: 14/035,296

(22) Filed: Sep. 24, 2013

(30) Foreign Application Priority Data
Jun. 26, 2013 (KR) 10-2013-0073609

(51) Int. Cl. G06F 1/32

(52) U.S. Cl. CPC G06F 1/3296
USPC 713/323

(57) ABSTRACT

There is provided a power supply apparatus which varies the state of operating power used for powering a main power supply depending on a load condition. The power supply apparatus includes: a standby power supply unit performing power-conversion on an input power to provide a predetermined standby voltage; and an operating power supply unit changing power transfer paths according to a predetermined load condition of a main power and varying states of an operating voltage used for power-conversion on the main power, to supply the varied operating voltage.

### CROSS-REFERENCE TO RELATED APPLICATIONS

This application claims the priority of Korean Patent Application No. 10-2013-0073609 filed on Jun. 26, 2013, in the Korean Intellectual Property Office, the disclosure of which is incorporated herein by reference.

### BACKGROUND OF THE INVENTION

1. Field of the Invention

The present invention relates to a power supply apparatus having increased power conversion efficiency.

2. Description of the Related Art

In general, various electronic apparatuses meeting various user needs have been variously implemented. These electronic apparatuses may use a power supply apparatus supplying operating power thereto in order to implement corresponding functions.

The power supply apparatus may generally employ a switched mode power supply scheme due to advantages thereof such as power conversion efficiency, miniaturization, and the like.

The types of such power supply apparatuses may include a power supply apparatus having a main power supply as well as operating and standby power supplies for powering the main power supply, in order to supply high-capacity power to an electronic apparatus requiring high-capacity power, such as a server.

In such a power supply apparatus, as disclosed in Patent Document 1 below, power is supplied to a load stage from various output stages. However, such a power supply maintains the voltage level of the operating voltage to supply main power at a constant voltage level, irrespective of a load condition, such that a high degree of voltage stress may be applied to a switch element or a control circuit on to which the operating voltage is supplied, and the efficiency of power conversion may be lowered.

### RELATED ART DOCUMENT

(Patent Document 1) Korean Patent Publication No. 10-0840668

### SUMMARY OF THE INVENTION

An aspect of the present invention provides a power supply apparatus which varies the state of operating power used for powering a main power supply depending on a load condition.

According to an aspect of the present invention, there is provided a power supply apparatus including: a standby power supply unit performing power-conversion on an input power to provide a predetermined standby voltage; and an operating power supply unit changing power transfer paths according to a predetermined load condition of a main power source and varying a voltage level of an operating voltage used for power-conversion on the main source, to supply the varied operating voltage.

The apparatus may further include: a control unit controlling the power transfer path for the operating power supply unit according to the load condition of the main power supply.

The operating power supply unit may include: a regulator varying the voltage level of an input power according to a set resistance ratio to output the operating voltage; and a setting unit varying the power transfer paths under the control of the control unit to set the state of the power input to the regulator.

The standby power supply unit and the operating power supply unit may share a power conversion stage, wherein the power conversion stage includes: a primary winding receiving a switched input power; a first secondary winding magnetically coupled to and having a predetermined turns ratio with the primary winding, and varying the voltage level of the power input to the primary winding so as to output the standby voltage; and a second secondary winding divided into two windings by a center tap, magnetically coupled to and having a predetermined turns ratio with the primary winding, and varying the voltage level of the power input to the primary winding so as to output power.

The setting unit may include: a first switch forming a transfer path for a voltage input to the regulator under the control of the control unit; a first diode connected between the center tap of second secondary winding and the regulator so as to form another transfer path for a voltage input to the regulator; a second diode connected between one end of the second secondary winding and the first switch so as to form a power transfer path to the first switch; and a second switch setting resistance ratio of the regulator under the control of the control unit.

According to another aspect of the present invention, there is provided a power supply apparatus including: a main power supply unit performing power-conversion on an input power according to control so as to supply a load with a predetermined main power; a main power control unit controlling power-conversion of the main power supply unit; and a power supply unit changing power transfer paths according to a load condition of the main power supply unit and varying the voltage level of the operating voltage supplied to the main power control unit so as to supply the varied operating voltage.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic circuit diagram of a power supply apparatus according to an embodiment of the present invention;

FIG. 2 shows a power supply apparatus for a server according to the embodiment of the present invention; and

FIG. 3 is a graph showing electrical characteristics of power supply apparatuses according to the related art and the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

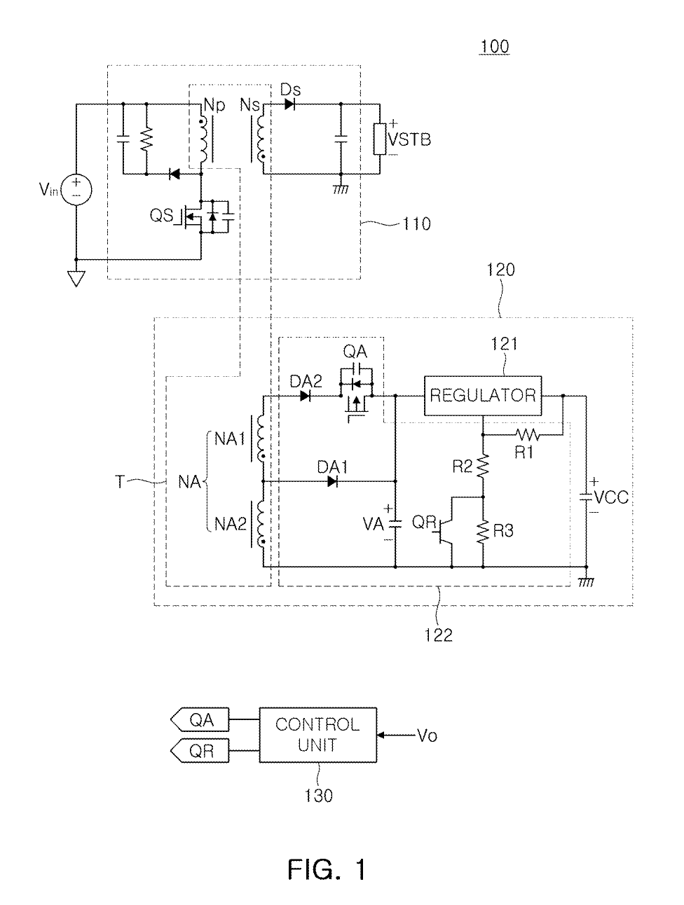

FIG. 1 is a schematic circuit diagram of a power supply apparatus according to an embodiment of the present invention.

Referring to FIG. 1, the power supply apparatus 100 according to the embodiment of the present invention may include a standby power supply unit 110 and an operating power supply unit 120. In addition, the power supply apparatus 100 may further include a control unit 130.

The standby power supply unit 110 may supply a predetermined standby voltage VSTB by switching an input voltage Vin.

The standby voltage VSTB may be used by a user's selection or in a standby mode, for example, before a main power is supplied in a power supplying circuit employing the power supply apparatus according to the embodiment.

The standby power supply unit 110 may include a power conversion stage operable to perform power conversion, and the power conversion stage may include a switch Qs for switching an input voltage Vin and a transformer T. The transformer T may include a primary winding Np having a predetermined number of turns and receiving the voltage switched by the switch Qs, and first and second secondary windings Ns and NA, each having a predetermined number of turns and magnetically coupled to the primary winding Np so as to have a predetermined turns ratio.

Here, the first secondary winding Ns may be used for supplying the standby voltage VSTB, and the second secondary winding NA may be used for supplying an operating voltage VCC by the operating power supply unit 120.

The second secondary winding NA may have a center tap to thereby be divided into NA1 and NA2.

The operating power supply unit 120 may share the power conversion stage with the standby power supply unit 110 so as to supply a main power circuit with the operating voltage Vcc necessary for the main power circuit to supply a main power.

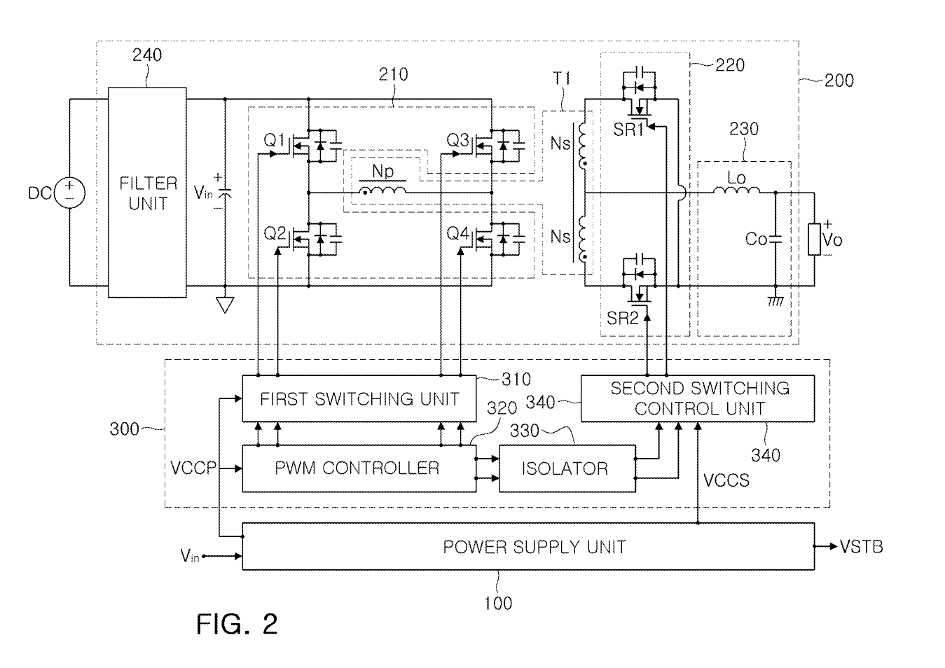

FIG. 2 shows a power supply apparatus for a server according to the embodiment of the present invention.

Referring to FIG. 2, the power supply apparatus for a server may include a power supply unit 110, a main power supply unit 200, and a main power control unit 300.

The main power supply unit 200 may include a switching unit 210, a transformer T1, a rectifying unit 220, stabilizing unit 230, and a filter unit 240.

The switching unit 210 may include a half-bridge or full-bridge switching elements Q1, Q2, Q3 and Q4, and may switch an input power DC on and off.

The transformer T1 may include a primary winding Np receiving the power switched by the switching unit 210, and a secondary winding Ns magnetically coupled to the primary winding Np and having a predetermined turns ratio. The secondary winding Ns transforms the voltage level of the power input to the primary winding Np according to the turns ratio.

The rectifying unit 220 may include synchronization switches SR1 and SR2, and may rectify the power from the secondary winding Ns in synchronization with the switching by the switching unit 210.

The stabilizing unit 230 may include an inductor Lo and a capacitor Co, and may stabilize the power rectified by the rectifying unit 220 by LC filtering and then output a main voltage Vo.

Moreover, the main power supply unit 200 may further include a filter unit 240 filtering electromagnetic interference in the input voltage DC to be transmitted to the switching unit 210.

The main power control unit 300 may include a first switching control unit 310 and a second switching control unit 340. Between the first switching control unit 310 and the second switching control unit 340, an isolator 330 such as an one-to-one transformer or a photo coupler may be included which is capable of sending and receiving signals with isolated primary and secondary sides.

The first switching control unit 310 and the second switching control unit 340 are operated by receiving operating voltages VCCP and VCCS from the power supply apparatus 100, respectively. The first switching control unit 310 may control the switching of the switching unit 210, and the second switching control unit 340 may control the switching of synchronized rectifying by the rectifying unit 220. The switching synchronization between the first switching control unit 310 and the second switching unit 340 may be made by transmitting a synchronization signal with the isolator 330.

Referring to FIG. 2 in conjunction with FIG. 1, in a typical power supply unit for a server, the main power control unit 300 for operating switching elements Q1, Q2, Q3 and Q4 of the switching unit 210 in the main power supply unit 200 is powered internally. To this end, the power supply apparatus 100 may include the standby power supply unit 110 and the operating power supply unit 120.

The operating power supply unit 120 shares the power conversion stage, especially the transformer T with the standby power supply unit 110, and may have bad cross regulation characteristics in auxiliary voltage for supplying the operating voltage VCC. Therefore, the operating power supply unit 120 may employ a regulator 121 to maintain the operating voltage VCC at a constant level.

Here, if the operating voltage VCC of a constant level is supplied to the main power supply unit 300 irrespective of a load condition of the main power supply unit, voltage stress may be applied and power loss may occur due to a high voltage level.

To this end, the operating power supply unit 120 may include a setting unit 122.

The setting unit 122 may set the state of a power input to the regulator 121 by varying a power transfer path from the transformer T under the control of the control unit 130.

Specifically, the setting unit 122 may include first and second switches QA and QR and first and second diodes DA1 and DA2.

The first switch QA may form a transfer path for a power input to the regulator 121 by being switched on/off under the control of the control unit 130.

The regulator 121 may vary a voltage level according to the set resistance ratio, which may be set by the second switch QR under the control of the control unit 130.

To this end, a group of resistors R1, R2 and R3 may be provided, and the resistance ratio may be determined in a such manner that the third resistor R3 is connected or disconnected depending on the switching of the second switch QR.

The first diode DA1 may be connected between the center tap of the second winding NA and the regulator 121 so as to form another transfer path for the power input to the regulator 121.

The second diode DA2 may be connected between one end of the secondary winding NA and the first switch QA so as to form a transfer path to the first switch QA.

The power transfer paths of the setting unit 122 may be set under the control of the control unit 130, and the control unit 130 may control the power transfer paths of the setting unit 122 depending on a load condition of the main voltage Vo of the main power supply unit 200.

Specifically, under a middle or heavy load condition, the first switch QA is switched on under the control of the control unit 130 so that power is supplied via the second diode DA2, and the second switch QR is switched off so that the auxiliary voltage VA input to the regulator 121 is increased in level by the voltage by the second secondary windings NA1+NA2. Accordingly, the regulator 121 provides an operating voltage VCC of a higher voltage level, such that conduction loss in the switching elements Q1 to Q4 of the switching unit 210 in the main power supply unit 200 may be minimized.

In contrast, under light load conditions, the first switch QA is switched off under the control of the control unit 130 so that power is supplied via the first diode DA1, and the second switch QR is switched on so that the auxiliary voltage VA input to the regulator 121 is decreased in level by the voltage by winding NA between the center tap and one end of the second secondary winding. Accordingly, the regulator 121 provides an operating voltage VCC of a lower voltage level.

That is, under the light load condition, the voltage levels of the auxiliary voltage VA and the operating voltage VCC are decreased, such that conduction loss in the switching elements Q1 to Q4 of the switching unit 210 in the main power supply unit 200 and power loss of the main power control unit 300 may be minimized, and thereby reducing voltage stress.

In addition, the level of a current flowing through the regulator 121 is also lowered, such that power loss generated in the regulator 121 is reduced as well.

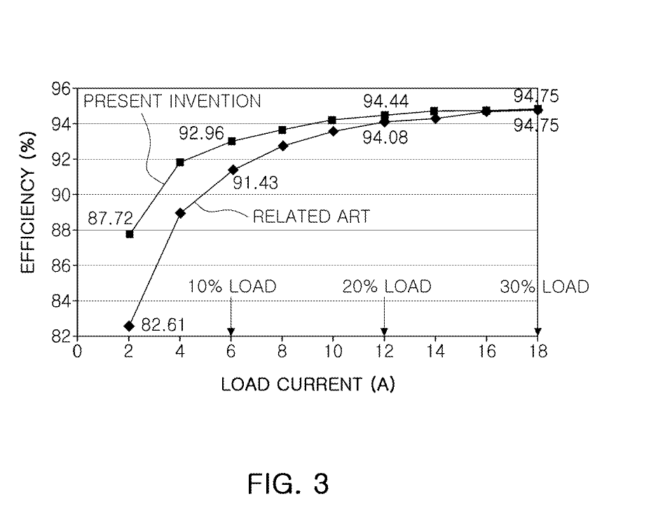

FIG. 3 is a graph showing electrical characteristics of power supply apparatuses according to the related art and the present invention.

In order to deduce the electrical characteristics shown in FIG. 3, the voltage level of the input power was set to be between 38 V and 75 V, the normal input voltage was set to be 48 V, the output voltage was set to be 12 V, and the output power was set to be 720 W.

The main power supply unit employed a phase-shift full-bridge converter.

Referring FIG. 3, according to the related art, the voltage levels of the operating voltages VCCP and VCCS supplied to the first and second switching control units 310 and 340 in the main power control unit and to a PWM controller 320 are 13 V irrespective of a load condition, whereas according to the embodiment of the present invention, the voltage levels of the operating voltages VCCP and VCCS are reduced to 8 V and 7 V, respectively, under a load condition of 30% or less.

As shown, compared to the related art, the power supply apparatus according to the present invention has efficiency improved by approximately 1.5% under a load condition of 10%, and has efficiency improved by a much greater amount under a load condition of below 10%.

That is, in the related art, under light load conditions, gate-driving loss and controller loss occupy much larger portions than conduction loss. A power supply apparatus according to the related art maintains the gate voltage at a high level, at 13 V for example, irrespective of a load condition. This method may reduce conduction loss but has considerable gate-driving loss, such that efficiency is lowered under light load conditions.

As set forth above, according to embodiments of the present invention, voltage stress applied to a main power control circuit can be reduced and power conversion efficiency can be improved by way of varying the voltage level of an operating voltage supplied to the main power control circuit depending on a load condition of a main power supply.

While the present invention has been shown and described in connection with the embodiments, it will be apparent to those skilled in the art that modifications and variations can be made without departing from the spirit and scope of the invention as defined by the appended claims.

What is claimed is:

1. A power supply apparatus comprising:
a standby power supply unit performing power-conversion on an input power so as to provide a predetermined standby voltage; and
an operating power supply unit changing power transfer paths according to a predetermined load condition of a main power supply and varying a voltage level of the operating voltage used for the power-conversion on the main power supply, to supply the varied operating voltage.

2. The apparatus of claim 1, further comprising a control unit controlling the power transfer path for the operating power supply unit according to the load condition of the main power supply.

3. The apparatus of claim 2, wherein the operating power supply unit includes:
a regulator varying the voltage level of the input power according to a set resistance ratio to output the operating voltage; and
a setting unit varying the power transfer paths under the control of the control unit to set the state of the power input to the regulator.

4. The apparatus of claim 3, wherein the standby power supply unit and the operating power supply unit share a power conversion stage, wherein the power conversion stage includes:
a primary winding receiving a switched input power;
a first secondary winding magnetically coupled to and having a predetermined turns ratio with the primary winding, and varying the voltage level of the power input to the primary winding so as to output the standby voltage; and
a second secondary winding divided into two windings by a center tap, magnetically coupled to and having a predetermined turns ratio with the primary winding, and varying the voltage level of the power input to the primary winding so as to output power.

5. The apparatus of claim 4, wherein the setting unit includes:
a first switch forming a transfer path for a voltage input to the regulator under the control of the control unit;
a first diode connected between the center tap of second secondary winding and the regulator so as to form another transfer path for a voltage input to the regulator;
a second diode connected between one end of the second secondary winding and the first switch so as to form a power transfer path to the first switch; and
a second switch setting resistance ratio of the regulator under the control of the control unit.

6. A power supply apparatus comprising:
a main power supply unit performing power-conversion on an input power according to control so as to supply a load with a predetermined main power;
a main power control unit controlling power-conversion of the main power supply unit; and
a power supply unit changing power transfer paths according to a load condition of the main power supply unit and varying the voltage level of the operating voltage supplied to the main power control unit so as to supply the varied operating voltage.

7. The apparatus of claim 6, wherein the power supply unit includes:
a standby power supply unit performing power-conversion on an input power to provide a predetermined standby voltage; and
an operating power supply unit changing power transfer paths according to a load condition of the main power supply unit and varying a state of the operating voltage, to supply the varied operating voltage.

8. The apparatus of claim 7, wherein the power supply unit further includes a control unit controlling the power transfer path for the operating power supply unit according to the load condition of the main power supply unit.

9. The apparatus of claim 8, wherein the operating power supply unit includes:
a regulator varying the voltage level of an input power according to a set resistance ratio to output the operating voltage; and
a setting unit varying the power transfer paths under the control of the control unit to set the state of the power input to the regulator.

10. The apparatus of claim 9, wherein the standby power supply unit and the operating power supply unit shares a power conversion stage, wherein the power conversion stage includes:
a primary winding receiving a switched input power;
a first secondary winding magnetically coupled to and having a predetermined turns ratio with the primary winding, and varying the voltage level of the power input to the primary winding so as to output the standby voltage; and
a second secondary winding divided into two windings by a center tap, magnetically coupled to and having a predetermined turns ratio with the primary winding, and varying the voltage level of the power input to the primary winding so as to output power.

11. The apparatus of claim 10, wherein the setting unit includes:
a first switch forming a transfer path for a voltage input to the regulator under the control of the control unit;
a first diode connected between the center tap of second secondary winding and the regulator so as to form another transfer path for a voltage input to the regulator;
a second diode connected between one end of the second secondary winding and the first switch so as to form a power transfer path to the first switch; and
a second switch setting resistance ratio of the regulator under the control of the control unit.
